(19) United States
(12) Patent Application Publication
(10) Pub. No.: US 2017/0289693 A1
(43) Pub. Date: Oct. 5, 2017

(54) VOICE COIL ASSEMBLY FOR SPEAKER

(71) Applicant: AAC Technologies Pte. Ltd., Singapore (SG)

(72) Inventors: Hongxing WANG, Shenzhen (CN); Lubin MAO, Shenzhen (CN)

(21) Appl. No.: 15/627,933

(22) Filed: Jun. 20, 2017

Related U.S. Application Data
(63) Continuation-in-part of application No. 15/006,397, filed on Jan. 26, 2016.

(51) Int. Cl. H04R 9/02; H04R 9/06

(52) U.S. Cl. CPC H04R 9/025; H04R 9/06

(57) ABSTRACT

A speaker is provided, includes a vibration system including a vibrating diaphragm and a voice coil assembly for driving the vibrating diaphragm, a magnetic circuit system including a first permanent magnet and a second permanent magnet, the voice coil assembly including a voice coil wire in flat and annular shape and a pair of voice coil brackets, each of the pair of voice coil brackets having a first wall, a second wall opposite to the first wall and a third wall positioned between the first wall and the second wall, the third wall fixed on the vibrating diaphragm, the voice coil wire sandwiched in between the first wall and the second wall of the pair of voice coil brackets.

### RELATED PATENT APPLICATION

This application is a continuation-in-part of U.S. patent application Ser. No. 15/006,397, filed Jan. 26, 2016, entitled “micro-speaker”, currently pending.

### FIELD OF THE DISCLOSURE

The present disclosure relates to electro-acoustic transducers, more particularly to a speaker having a diaphragm driven by a voice coil.

### DESCRIPTION OF RELATED ART

With the rapid development of technology, audio devices are more and more popular. The people require not only the audio playing function of the audio devices, but also require higher reliability of audio devices. As more mobile multimedia technologies are developed particularly in 3G era, many audio devices are provided with many entertainment features, such as video playback, digital camera, games, GPS navigation and so on, more sophisticated and compact electronic components are required in audio devices.

The speaker is a common electronic component in audio devices and is used mainly for playback of audio signals. In the existing audio devices, the thickness of mobile phone, for example, is smaller, so that the speaker shall be thinner also. If the speaker is too thin, the vibration amplitude of the vibrating diaphragm is reduced, that will affect seriously the low frequency performance of the speaker. Therefore, the existing long stroke speaker with better low frequency performance is developed and the thickness is small enough, so that such a speaker can solve well the problems of traditional speaker.

Conventional voice coil assemblies manufactured by way of photochemical etching processes, comprises a nonconductive substrate and a metallic spiral pattern layer made on the substrate. The metallic spiral pattern layer functions as a voice coil and the substrate having the voice coil is supported by a suitable holder at the periphery of the substrate, while permanent magnets are located in the vicinity of the coil so that the substrate vibrates when the coil is energized by an input signal. As is well known, the voice coil tends to generate heat when energized. The degree of this heat generation is a function of the power of the input signal. Since the voice coil is made from a thin microstripline, a high temperature may cause the voice coil to burn out. Therefore, the allowable maximum input power is simply determined by the resistivity of the coil and the efficiency of the heat dissipation. The resistivity of the coil is determined by the thickness and the width of the coil and both the thickness and the width thereof cannot be increased for the following reasons. In addition to the above described disadvantages of the conventional voice coil assembly, the frequency characteristic of the conventional speaker of the type above mentioned is not flat because of the existence of standing waves across the voice coil.

Therefore, it is necessary to provide a new speaker to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric exploded view of a speaker in accordance with an exemplary embodiment of the present disclosure.

FIG. 2 is a cross-sectional view of the speaker in FIG. 1.

FIG. 3 depicts an assembled view of a diaphragm and a voice coil assembly.

FIG. 4 depicts an assembled view of the diaphragm and the voice coil assembly in FIG. 3, from another aspect.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

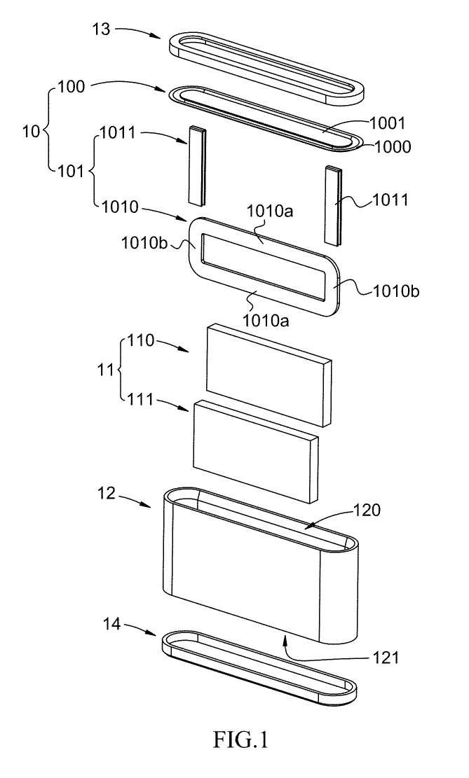

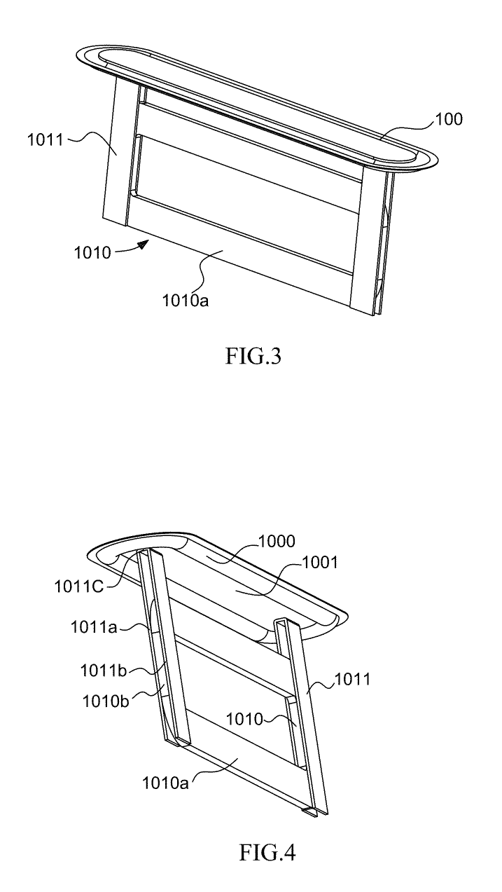

As shown in FIGS. 1 through 4, a speaker 1 in accordance with an exemplary embodiment of the present disclosure, includes a vibration system 10, a magnetic circuit system 11, a housing 12 for assembling the vibration system 10 and the magnetic circuit system 11, a front cover 13 and a rear cover 14 assembled on the housing 12 to create a space to accommodate the vibration system 10 and the magnetic circuit system 11.

The magnetic circuit system 11 includes a first permanent magnet 110 and a second permanent magnet 111 separated from the first permanent magnet 110, opposite magnetic poles of the first and second permanent magnets being faced to each other. The first permanent magnet 110 and the second permanent magnet 111 are fixed respectively on an inner surface of the housing 12. The gap between the first permanent magnet 110 and the second permanent magnet 111 is defined as a magnetic gap 112. Two magnetic poles of the first permanent magnet 110 and two magnetic poles of the second permanent magnet 111 are close to each other respectively. N-pole of the first permanent magnet 110 and S-pole of the second permanent magnet 111 are separated and faced each other. S-pole of the first permanent magnet 110 and N-pole of the second permanent magnet 111 are separated and faced each other. A distance between the N-pole of the first permanent magnet 110 and S-pole of the second permanent magnet 111 is equal to the spacing distance between S-pole of the first permanent magnet 110 and N-pole of the second permanent magnet 111. Therefore, the first permanent magnet 110 and the second permanent magnet 111 are parallel to each other.

The vibration system 10 includes a vibrating diaphragm 100 with an edge thereof fixed on the housing 12 and a voice coil assembly 101 which drives the vibrating diaphragm 100 to vibrate. One end of the voice coil assembly is suspended in the magnetic gap 112. The vibrating diaphragm 100 includes a corrugated rim 1000 with a periphery thereof fixed on the housing 12, and a center dome top 1001 connected to the corrugated rim 1000. In the embodiment, the center dome top in shaped of flat plate is surrounded by the corrugated rim 1000.

The voice coil assembly 101 includes a voice coil wire 1010 in flat and annular shape and a pair of voice coil brackets 1011 fixed on the center dome top 1001 of the diaphragm 100. The voice coil wire 1010 is fixed on the pair of voice coil brackets 1011. In the embodiment, the voice coil wire 1010 includes a pair of long siders 1010a and a pair of short siders 1010b for forming an oblong and laminar structure that is like rectangular. Each of the pair of voice coil brackets 1011 has a first wall 1011a and a second wall 1011b opposite to the first wall 1011a, and a third wall 1011c positioned between the first wall 1011a and the second wall 1011b. The voice coil wire 1010 is sandwiched in between the first wall 1011a and the second wall 1011b in the in the magnetic gap 112.

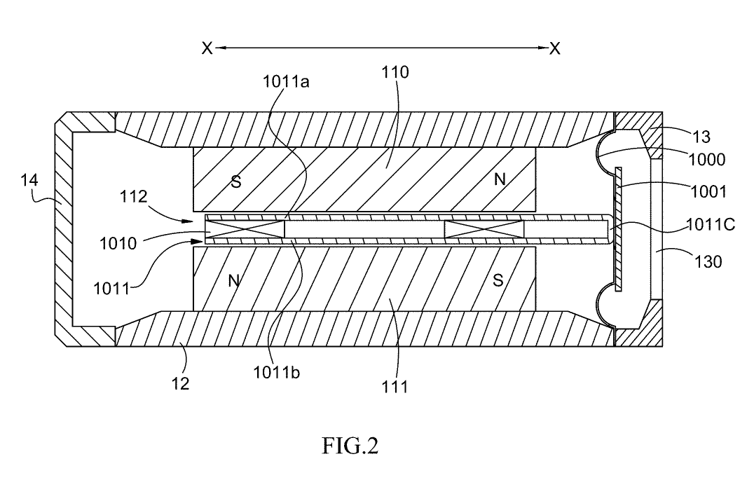

As shown especially in FIGS. 1 through 2, the third wall 1011c of each of the pair of voice coil brackets is fixed on the center dome top 1001 of the diaphragm 100. For improving the vibration amplitude, the material of the voice coil brackets 1011 is different from the material made of the diaphragm 100. The voice coil brackets 1011 material must be harder than the material of the center dome top 1001 of the diaphragm 100. In the present embodiment, two ends of the voice coil wire 1010 are wedged corresponding to in a narrow space of the voice coil brackets 1011, respectively. Particularly, the short sider 1010b of the voice coil wire 1010 is sandwiched in between the first wall 1011a and the second wall 1011b.

The voice coil wire 1010 vibrates in reciprocating mode in the magnetic gap 112 between N-pole of the first permanent magnet 110 and S-pole of the second permanent magnet 111, and between S-pole of the first permanent magnet 110 and N-pole of the second permanent magnet 111 along the vibration direction X-X of the vibration system 10. The vibration of the voice coil wire 1010 is transferred to the vibrating diaphragm 100 through the coil bracket 1011 to drive the vibrating membrane 100 to vibrate and make sound. The first permanent magnet 110 and the second permanent magnet 111 are magnetized along the vibration direction X-X of the vibration system 10, i.e. magnetized along the major axis direction of the first permanent magnet 110 and the second permanent magnet 111.

The cross section of the housing 12 is in flat runway tubular shape. The housing 12 includes a front opening 120 for assembling the vibrating diaphragm 100 and a rear opening 120 corresponding to the front opening 121. The front opening 120 and the rear opening 121 are communicated with each other. The front cover 13 is installed on the front opening 120. The rear cover 14 is installed on the rear opening 121. The front cover 13 is provided also with a sound outlet 130. The circumferential edge of the vibrating diaphragm 100 is fixed between the front cover 13 and the housing 12.

In the speaker 1 disclosed above, the vibrating diaphragm 100 can have bigger vibration amplitude, so that the speaker 1 has a better low-frequency sound effect. In addition, the magnetic circuit system 11 needs only the first permanent magnet 110 and the second permanent magnet 111, which are separated with their opposite magnetic poles faced each other. The magnetic circuit system is much simple. The magnetic circuit system 11 is easier to be assembled.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker, comprising:
a vibration system including a vibrating diaphragm and a voice coil assembly for driving the vibrating diaphragm;
a magnetic circuit system including a first permanent magnet and a second permanent magnet, which are separated with opposite magnetic poles thereof facing each other;
a magnetic gap formed between the first permanent magnet and the second permanent magnet for partially receiving the voice coil assembly; wherein
the voice coil assembly includes a voice coil wire in flat and annular shape and a pair of voice coil brackets, each of the pair of voice coil brackets having a first wall, a second wall opposite to the first wall and a third wall positioned between the first wall and the second wall, the third wall fixed on the vibrating diaphragm;
the voice coil wire is sandwiched between the first wall and the second wall of the pair of voice coil brackets.

2. The speaker according to claim 1, wherein rigidity of the voice coil bracket is harder than rigidity of the vibrating diaphragm.

3. The speaker according to claim 1, wherein the voice coil wire includes a pair of long siders and a pair of short siders for forming an oblong and laminar structure, each short sider is clipped by the first wall and the second wall of a corresponding voice coil brackets.

4. The speaker according to claim 2, wherein the vibrating diaphragm includes a corrugated rim and a center dome top in shaped of flat plate surrounded around the corrugated rim, the third wall of the voice coil bracket fixed on the center dome top.

5. The speaker according to claim 2, wherein two magnetic poles of the first permanent magnet and two magnetic poles of the second permanent magnet are close to each other respectively, N-pole of the first permanent magnet is separated from and faces S-pole of the second permanent magnet, while S-pole of the first permanent magnet is separated from and faces N-pole of the second permanent magnet.

6. The speaker according to claim 2, wherein a housing includes a front opening for assembling the vibrating diaphragm and a rear opening corresponding to and communicating with the front opening.

7. The speaker according to claim 6 further including a front cover for the front opening and a rear cover for the rear opening, and an edge of the vibrating diaphragm is fixed between the front cover and the housing.

8. The speaker according to claim 7, wherein the first magnet and the second magnet are fixed respectively on an inner surface of the housing.

9. The speaker according to claim 8, wherein the first permanent magnet is parallel to the second permanent magnet.
